(19) United States
(12) Patent Application Publication
(10) Pub. No.: US 2026/0103068 A1
(43) Pub. Date: Apr. 16, 2026

(54) COMBINED OPEN VENT AND EMERGENCY RELIEF VENT

(71) Applicant: Discovery Energy, LLC, Kohler, WI (US)

(72) Inventors: William GYSI, Sheboygan, WI (US); Adam CLOUSE, Howards Grove, WI (US)

(73) Assignee: Discovery Energy, LLC, Kohler, WI (US)

(21) Appl. No.: 19/356,469

(22) Filed: Oct. 13, 2025

Related U.S. Application Data
(60) Provisional application No. 63/707,082, filed on Oct. 14, 2024.

(51) Int. Cl. B60K 15/035; B60K 15/03

(52) U.S. Cl. CPC B60K 15/035; B60K 2015/03296; B60K 2015/03447

(57) ABSTRACT

A fuel tank comprising a tank and a venting system is disclosed. The tank comprises a housing defining a tank cavity and a port defined in the housing in communication with the tank cavity. The venting system comprises a base attached to the housing, wherein the base defines a base cavity in fluid communication with the tank cavity through the port and a relief housing movably connected to the base, wherein the relief housing is movable between a first position and a second position, wherein a sealed interface is defined between the base and the relief housing when the relief housing is in its first position, wherein the relief housing comprises an open vent aperture in fluid communication with the base cavity, and wherein the sealed interface is unsealed when the relief housing is in its second position to expose a relief vent aperture in the base.

### CROSS-REFERENCE TO RELATED APPLICATION

This non-provisional application claims the benefit of U.S. Provisional Patent Application No. 63/707,082 , entitled COMBINED OPEN VENT AND EMERGENCY RELIEF VENT, which was filed on Oct. 14, 2024, the entire disclosure of which is incorporated by reference herein.

### BACKGROUND

A fuel tank, such as a diesel storage tank, for example, is often used to supply fuel to a generator. In various instances, a fuel tank provides a subbase, or pedestal, to the generator. In other instances, a fuel tank can be mounted to a skid or a trailer, for example, positioned adjacent the generator. Regardless of the application, a fuel tank may experience changes in internal pressure and a venting system may be needed to modulate the pressure in the fuel tank. In various instances, a fuel tank may have a vent that is continuously open to the surrounding environment that can relieve both vacuum and moderately-elevated pressure conditions in the fuel tank. Such vents, however, may be inadequate to relieve high pressure conditions that may occur when the vent is blocked and/or during a fire, for example. To account for such high-pressure conditions, a fuel tank may also have an emergency relief vent that can open to relieve the pressure from the fuel tank. Having a separate open vent and emergency relief vent requires additional welding, assembly time, and space claim on the fuel tank.

### BRIEF DESCRIPTION OF THE DRAWINGS

Exemplary embodiments are described herein with reference to the following drawings.

FIG. 1 is a perspective view of a fuel storage tank assembly in accordance with at least one embodiment of the present invention;

FIG. 2 is a detail view of two venting assemblies of the fuel storage tank assembly of FIG. 1;

FIG. 3 is a plan view of the fuel storage tank assembly of FIG. 1;

FIG. 4 is a cross-sectional elevational view of the fuel storage tank assembly of FIG. 1;

FIG. 5 is a cross-sectional detail view of the fuel storage tank assembly of FIG. 1 illustrating the venting assemblies of FIG. 2 in a vent configuration;

FIG. 6 is a perspective view of a venting assembly of FIG. 2 illustrated in a relief configuration;

FIG. 7 is an elevational view of the venting assembly of FIG. 2 illustrated in the relief configuration of FIG. 6;

FIG. 8 is a cross-sectional elevational view of the venting assembly of FIG. 2 illustrated in the relief configuration of FIG. 6;

FIG. 9 is a perspective view of a venting assembly in accordance with at least one alternative embodiment illustrated in a vent configuration;

FIG. 10 is an elevational view of the venting assembly of FIG. 9 illustrated in the vent configuration of FIG. 9;

FIG. 11 is a cross-sectional elevational view of the venting assembly of FIG. 9 illustrated in the vent configuration of FIG. 9;

FIG. 12 is a perspective view of the venting assembly of FIG. 9 illustrated in a relief configuration;

FIG. 13 is an elevational view of the venting assembly of FIG. 9 illustrated in the relief configuration of FIG. 12; and

FIG. 14 is a cross-sectional elevational view of the venting assembly of FIG. 9 illustrated in the relief configuration of FIG. 12.

### DETAILED DESCRIPTION

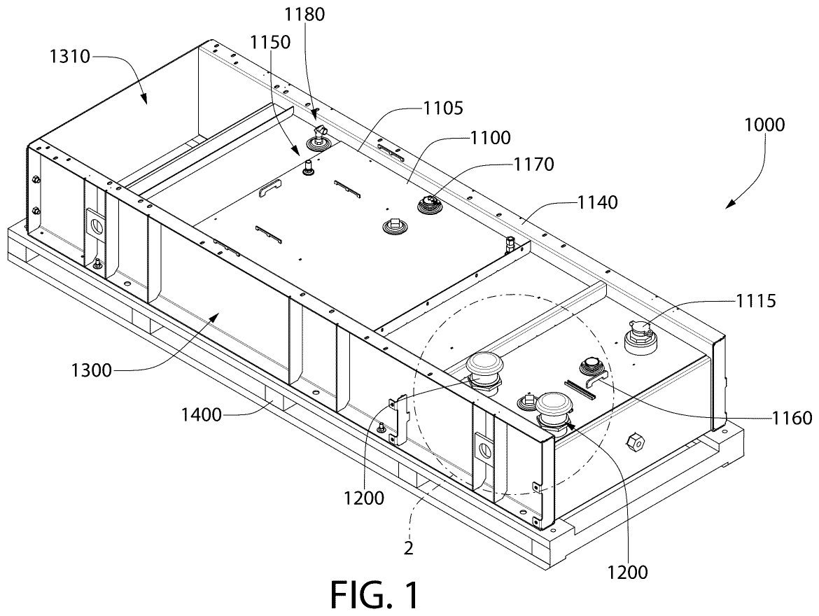

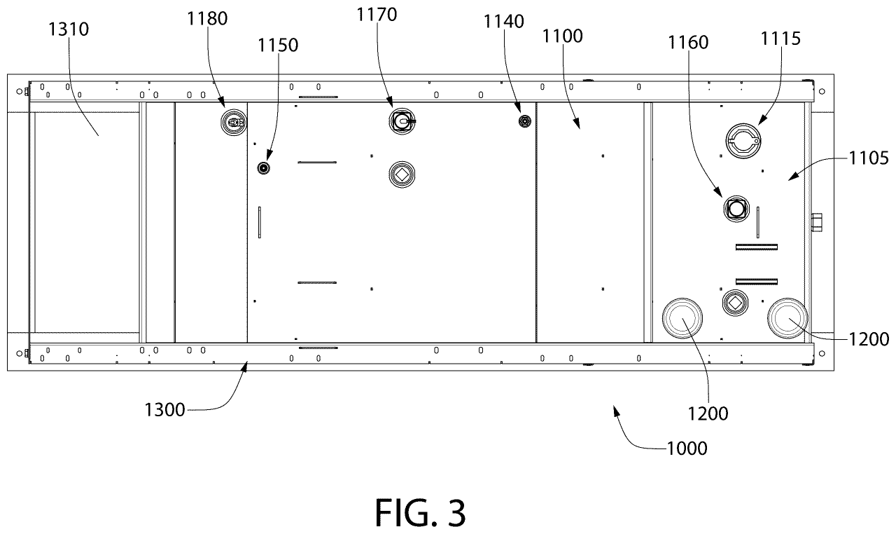

A fuel storage tank assembly 1000 for use with a generator, for example, is illustrated in FIGS. 1-5. The fuel storage tank assembly 1000 comprises a fuel tank 1100, a containment housing 1300, and a base 1400. The containment housing 1300 is typically comprised of steel but can be comprised of any number of inert materials such as plastic and/or fiberglass, for example, and is mounted to the base 1400, which can comprise a skid, for example. That said, embodiments are envisioned without a containment housing 1300 and/or base 1400. The fuel tank 1100 is at least partially positioned in the containment housing 1300 and comprises a housing 1105 comprised of metal, such as stainless steel and/or aluminum, for example, that is at least partially coated in rust preventative such as Rehlko's POWER ARMOR PLUS rubberized coating, powder coating, and/or a number of other coatings, for example. The housing 1105 comprises an inner tank 1120 and an outer tank 1130. The inner tank 1120 defines a sealed space that can be filled with fuel, such as diesel or kerosene, for example, through a filling port 1115 that includes a cap that can be opened and closed as needed. The inner tank 1120 is positioned in the outer tank 1130 which defines a sealed space configured to contain fuel that may escape from the inner tank 1120, for example.

The fuel tank 1100 further comprises a fuel supply diptube 1140 mounted to the housing 1105 that comprises an upper end extending outside of the housing 1105 and a lower end extending into the inner tank 1120. The upper end of the fuel supply diptube 1140 is configured to be placed in communication with the generator via a flexible fuel line, for example. In various embodiments, the upper end of the fuel supply diptube 1140 further comprises a check valve configured to close the fuel supply dip tube 1140 except when the fuel pump of the generator is drawing fuel from the inner tank 1120 through the fuel supply diptube 1140. The fuel tank 1100 further comprises a return diptube 1150 mounted to the housing 1105 that comprises an upper end extending outside of the housing 1105 and a lower end extending into the outer tank 1130. In the event that fuel is bypassed through a fuel bleeder line in the generator, for example, the bypassed fuel can return to the fuel tank 1100 via the return diptube 1150.

The fuel tank 1100 further comprises a fuel level sensor 1160 mounted to the housing 1105 that comprises an electrical connector that extends outside of the housing 1105 and a fuel height sensing element that extends into the inner tank 1120. In various embodiments, the fuel level sensor 1160 comprises a buoyant member that floats on the top surface of the fuel in the inner tank 1120, the position of which being detectable by the fuel level sensor 1160. That said, the fuel level sensor 1160 can comprise any suitable configuration. The fuel tank 1100 also comprises a fuel level sensor 1170 mounted to the housing 1105 that comprises an electrical connector that extends outside of the housing 1105 and a fuel height sensing element that extends into the outer tank 1130. Similar to the fuel level sensor 1160, the fuel level sensor 1170 comprises a buoyant member that floats on the top surface of the fuel in the outer tank 1130, the position of which being detectable by the fuel level sensor 1170. That said, the fuel level sensor 1170 can comprise any suitable configuration.

In various embodiments, further to the above, the fuel storage tank assembly 1000 further comprises an electrical wiring harness connected to the electrical connectors of the fuel level sensors 1160, 1170 that places the fuel level sensors 1160, 1170 in signal communication with a controller of the generator such that the generator controller can receive data from the fuel level sensors 1160, 1170. Using the data from the fuel level sensors 1160, 1170, the generator controller can determine the height of the fuel in the inner tank 1120, and the amount of fuel remaining in the inner tank 1120, and assess the remaining run time of the generator. In addition to or in lieu of the above, the fuel tank assembly 1000 can comprise a controller configured to, among other things, monitor the fuel level in the inner tank 1120 and the outer tank 1130. In such embodiments, the electrical wiring harness can place the fuel level sensors 1160, 1170 in signal communication with the controller of the fuel storage tank assembly 1000. In at least one such embodiment, the controller of the fuel storage tank assembly 1000 is positioned in an electrical stub-up 1310 defined in the containment housing 1300; however, the controller can be positioned in any suitable location within the fuel tank assembly 1000, attached to any suitable location of the fuel tank assembly 1000, within the generating set assembly, and/or remotely mounted elsewhere.

Further to the above, the fuel tank 1100 further comprises a leak detection sensor 1180 mounted to the housing 1105. The leak detection sensor 1180 comprises an upper end including an electrical connector that extends outside of the housing 1105 and a lower end extending into the outer tank 1130. Similar to the above, the leak detection sensor 1180 is in signal communication with the generator controller and/or the controller of the fuel tank assembly 1000 through an electrical wiring harness. Such an electrical wiring harness can be the same electrical wiring harness that places the fuel level sensors 1160, 1170 in signal communication with the generator controller and/or the controller of the fuel tank assembly 1000 or a different electrical wiring harness. In either event, the generator controller and/or the controller of the fuel tank assembly 1000 is configured to evaluate the level of the fuel in the outer tank 1130 and assess whether there is a fuel leak from the inner tank 1120 into the outer tank 1130 and/or a fuel leak out of the outer tank 1130.

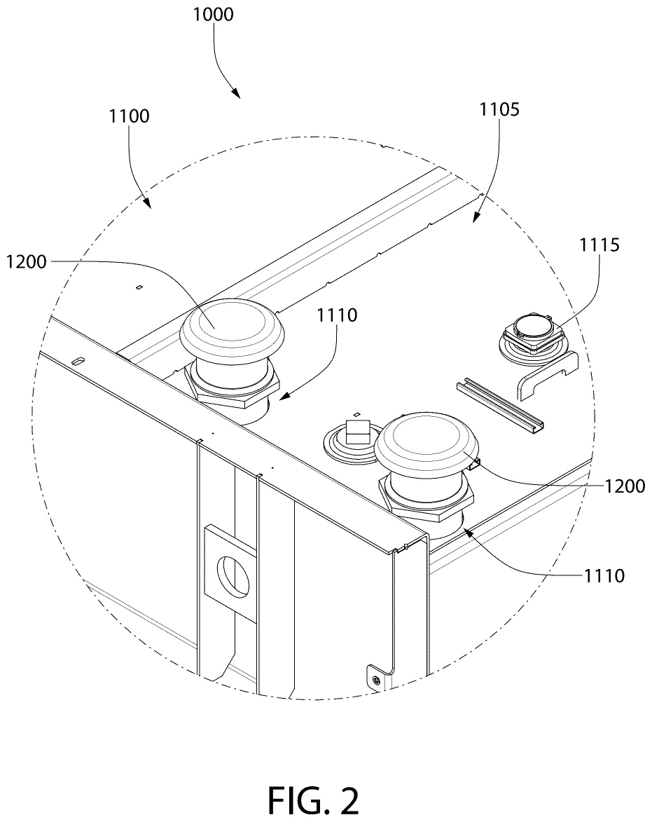

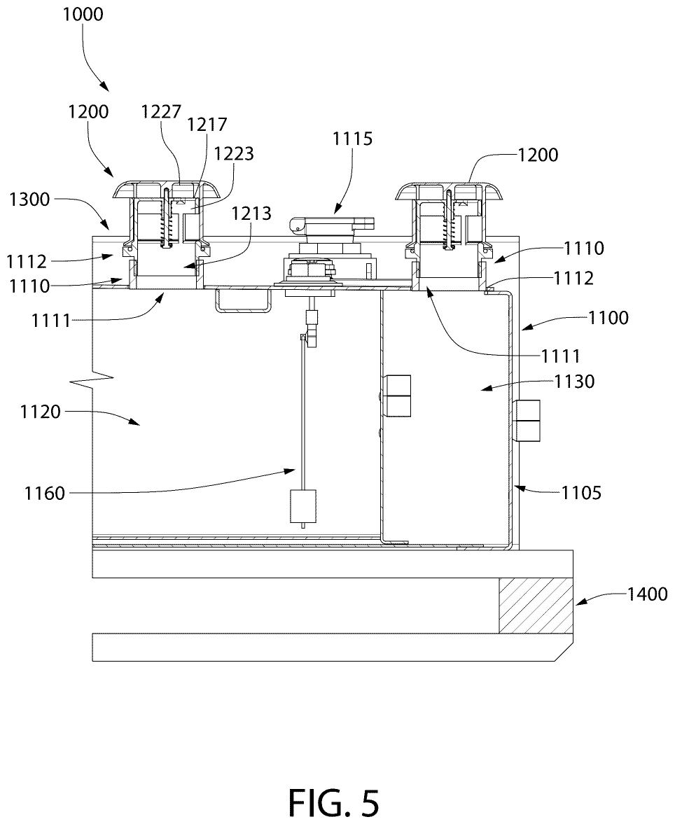

Referring primarily to FIGS. 2 and 5, the housing 1105 comprises a first vent port 1110 in communication with the inner tank 1120 and a second vent port 1110 in communication with the outer tank 1130. The first vent port 1110 comprises an aperture 1111 defined in the housing 1105 that places the inner tank 1120 in communication with the surrounding atmosphere and, also, a threaded collar 1112 extending around the aperture 1111. Similarly, the second vent port 1110 comprises an aperture 1111 defined in the housing 1105 that places the outer tank 1130 in communication with the surrounding atmosphere and a threaded collar 1112 extending around the aperture 1111.

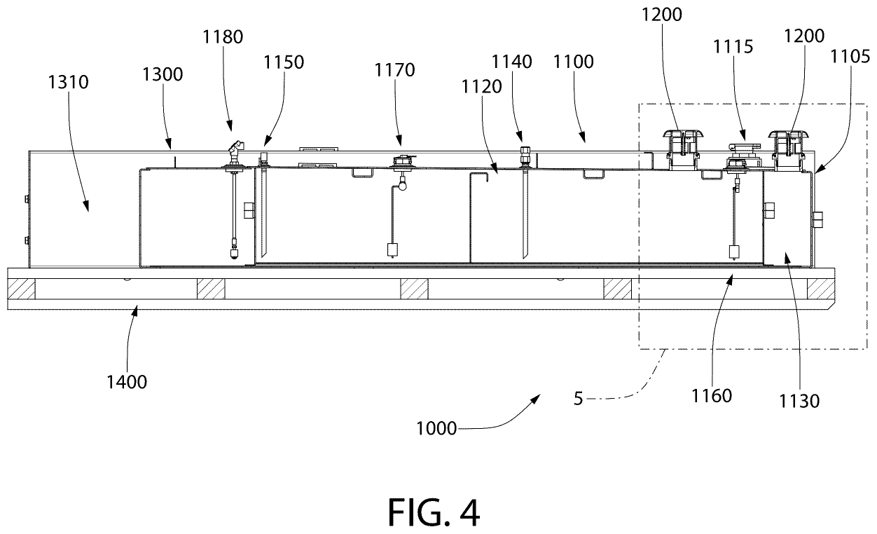

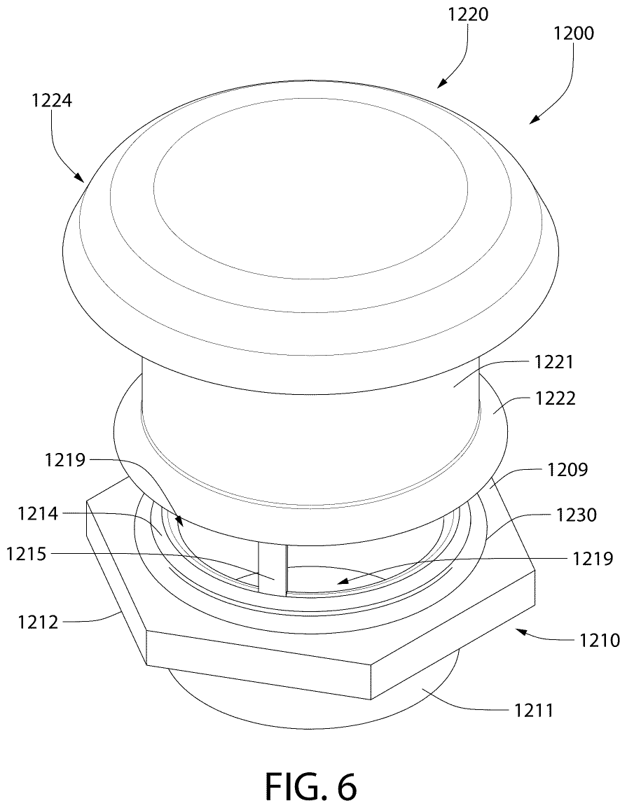

Further to the above, a venting assembly 1200 is mounted to each vent port 1110. More specifically, referring to FIGS. 4 and 6, each venting assembly 1200 comprises a base 1210 threadably engaged with the collar 1112 of a vent port 1110. The base 1210 comprises a threaded stem 1211 that threadably engages the collar 1112 and a drive, or hex, interface 1212 configured to be engaged by a wrench, for example, that can be used to rotate the base 1210 relative to the housing 1105 and tighten the base 1210 to the housing 1105. The threads connecting the base 1210 to the housing 1105 can have any suitable configuration, such as NPT pipe threads, for example, and can be sealed to prevent the ingress of water, for example, into the fuel tank 1100. In addition to or in lieu of a threaded interface between the base 1210 and the housing 1105, the base 1210 can be welded, press-fit, and/or bolted to the housing 1105, for example.

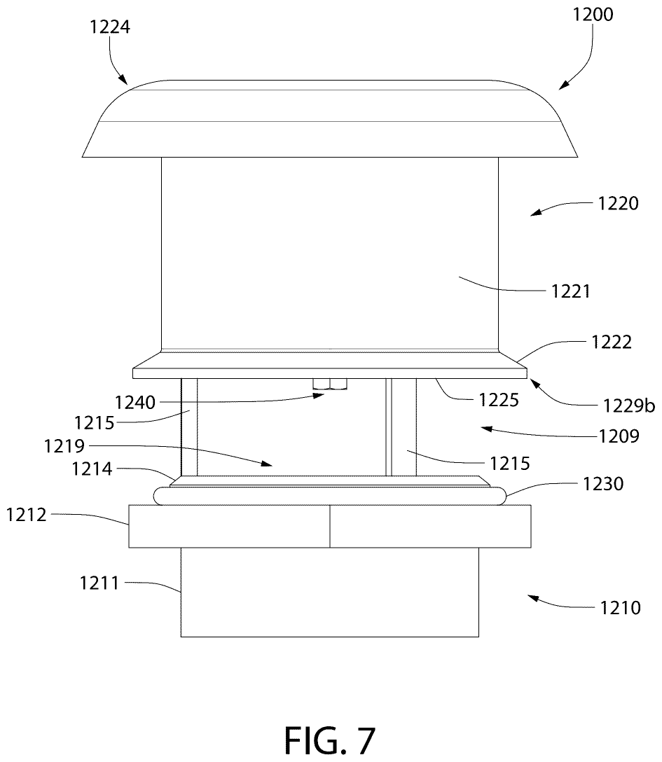

Further to the above, each venting assembly 1200 further comprises a relief housing 1220 movably mounted to the base 1210. The relief housing 1220 is movable between a first position and a second position to shift the venting assembly 1200 between a first, or vent, configuration which is illustrated in FIGS. 1-5, and a second, or relief, configuration which is illustrated in FIGS. 6-8. When the venting assembly 1200 is in its vent configuration, as illustrated in FIG. 5, gasses in the inner tank 1120, for example, can flow through the first vent port 1110, through the venting assembly 1200 mounted to the first vent port 1110, and into the surrounding atmosphere. More specifically, the gasses can flow through the aperture 1111 of the first vent port 1110 into a cavity 1213 defined in the base 1210, through the cavity 1213 defined in the base 1210 into a cavity 1223 defined in the relief housing 1220 via one or more openings 1217 defined in the base 1210, and through the cavity 1223 defined in the relief housing 1220 into the surrounding atmosphere via one or more vent openings 1227 defined in the relief housing 1220. As a result of this arrangement, the venting assembly 1200 provides, at a minimum, a continuously-open vent between the inner tank 1120 and the atmosphere when the venting assembly 1200 is in its vent configuration.

Further to the above, referring primarily to FIGS. 6-8, the relief housing 1220 further comprises a shield 1224 that extends laterally with respect to the vent openings 1227 and circumferentially around the vent openings 1227. The shield 1224 has a mushroom-shaped configuration that extends laterally outwardly and slopes generally downwardly, i.e., toward the tank housing 1105, such that the vent openings 1227 are entirely covered from above and from the side. As a result of this configuration, the shield 1224 can prevent, or at least inhibit, rain, for example, from entering into the venting assembly 1200. Moreover, the shield 1224 of the relief housing 1220 is the widest part of the venting assembly 1200 and, as a result, the shield 1224 can at least partially protect one or more sealed interfaces of the venting assembly 1200, discussed below, from the environment. The above being said, the shield 1224 can comprise any suitable configuration.

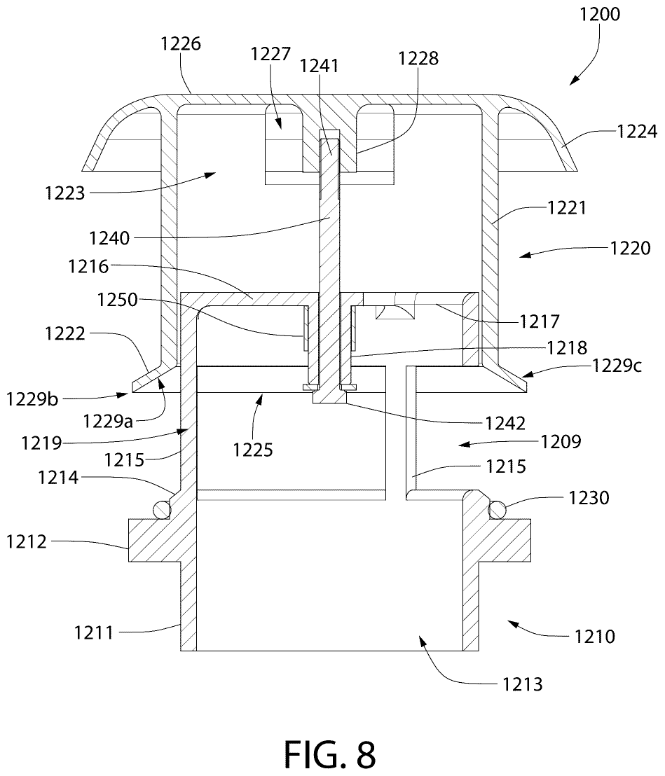

Further to the above, referring primarily to FIG. 8, the venting assembly 1200 further comprises a seal 1230 extending around the base 1210 that creates a sealed interface between the base 1210 and the relief housing 1220 when the venting assembly 1200 is in its vent configuration (FIGS. 1-5). The seal 1230 comprises a synthetic rubber o-ring, for example, but can comprise any suitable configuration and can be comprised of any suitable material. In at least one such embodiment, the o-ring has a circular cross-section, but can comprise any suitable cross-section. The seal 1230 extends around a seal interface 1214 of the base 1210 in a partially-expanded state and, as a result, creates a sealed interface between the seal 1230 and the seal interface 1214. Moreover, the seal 1230 is positioned against the drive interface 1212 of the base 1210 and is compressed against the drive interface 1212 by the relief housing 1220 when the venting assembly 1200 is in its vent configuration. More specifically, the relief housing 1220 is biased into its first position by a return spring 1250, discussed in greater detail below, and, when the relief housing 1220 is held in its first position by the spring 1250, the relief housing 1220 compresses the seal 1230 against the drive interface 1212 of the base 1210 and, as a result, creates a sealed interface between the seal 1230 and the drive interface 1212. Moreover, in such instances, the spring 1250 creates a sealed interface between a flange, or skirt, 1222 of the relief housing 1220 and the seal 1230 such that gasses venting from the inner tank 1120 exit the venting assembly 1200 through the vent openings 1227, as described above, when the venting assembly 1200 is in its first, or vent, configuration.

Further to the above, the relief housing 1220 is slideably connected to the base 1210. The base 1210 comprises a cylindrical body 1215 that is closely received within a cylindrical body 1221 of the relief housing 1220 such that the cylindrical body 1215 can define a path along which the relief housing 1220 can translate as the relief housing 1220 moves between its first and second positions as described above. The cylindrical body 1215 of the base 1210 further comprises an end wall 1216 and a collar 1218 extending from the end wall 1216. Further to the above, the end wall 1216 comprises the openings 1217 defined therein that fluidly connect the cavity 1213 of the base 1210 with the cavity 1223 of the relief housing 1220. The collar 1218 comprises a longitudinal aperture defined therein which is configured to receive a fastener 1240 extending therethrough which movably connects the relief housing 1220 to the base 1210. The fastener 1240 comprises a threaded end 1241 threaded into a mounting aperture, or boss, 1228 defined in the relief housing 1220, a shaft that extends through the longitudinal aperture defined in the collar 1218, and an enlarged head 1242 positioned on the opposite side of the collar 1218. The fastener 1240 comprises a screw, for example, but can comprise any suitable fastener. The spring 1250, mentioned above, comprises a linear coil spring, for example, compressed between the head 1242 of the fastener 1240 and the end wall 1216 such that the spring 1250 tends to bias the relief housing 1220 into its first position, as described above. In various instances, a washer can be positioned intermediate the spring 1250 and the head 1242 of the fastener 1240 to provide a large bearing area for the spring 1250. When the relief housing 1220 is in its first position, further to the above, the spring 1250 is in a compressed state and, owing to the resiliency of the spring 1250, the spring 1250 tends to push the head 1242 away from the end wall 1216 and, as a result, pull the relief housing 1220 toward the seal 1230 positioned intermediate the base 1210 and the relief housing 1220. When the relief housing 1220 is pushed upwardly into its relief position by gasses flowing through the venting assembly 1200, as described below, the spring 1250 is further compressed between the fastener head 1242 and the end wall 1216 of the base 1210. The collar 1218 of the base 1210 extends longitudinally through the spring 1250 and is sized and configured to prevent, or at least inhibit, the spring 1250 from buckling.

Further to the above, the cavity 1213 defined in the base 1210, the openings 1217 defined in the end wall 1216 of the base 1210, the cavity 1223 defined in the relief housing 1220, and the vent openings 1227 defined in the relief housing 1220 are all sized and configured to permit gasses to flow out of the fuel tank 1100 into the surrounding atmosphere. That said, the gasses flowing through the relief housing 1220 can contact an end wall 1226 of the relief housing 1220 before exiting through the vent openings 1227 and, as a result, apply a lifting force to the relief housing 1220 that tends to move the relief housing 1220 away from the base 1210. The magnitude of the lifting force applied to the relief housing 1220 is a direct function of the pressure and/or flow rate of the gasses flowing through the relief housing 1220. For instance, larger gas pressures result in a larger lifting force while lower gas pressures result in a smaller lifting force. Also, for instance, larger flow rates result in a larger lifting force while lower flow rates result in a smaller lifting force. However, the lifting force applied to the relief housing 1220 by the gasses, regardless of its magnitude, is opposed by the biasing force applied to the relief housing 1220 by the return spring 1250. When the lifting force exceeds the biasing force, the relief housing 1220 can move from its first position toward its second position thereby transitioning the vent assembly 1200 from its vent configuration into its relief configuration.

As discussed above, gasses flowing through the venting assembly 1200 at an elevated pressure and/or flow rate can push the relief housing 1220 away from the base 1210 of the venting assembly 1200. As the relief housing 1220 is lifted away from the base 1210, further to the above, the relief housing 1220 loses contact with, or at least partially loses contact with, the seal 1230 to create a circumferential relief gap 1209 defined between, or at least partially between, the skirt 1222 of the relief housing 1220 and the seal 1230. In at least one embodiment, the relief housing 1220 can disengage from the seal 1230 when the pressure of the gas in the inner tank 1120 exceeds 2.5 psig, for example. In at least one embodiment, the relief housing 1220 can disengage from the seal 1230 when the pressure of the gas in the inner tank 1120 exceeds a pressure less than 2.5 psig, such as 0.25 psig, for example. In such instances, gas from the inner tank 1120 can flow through the cavity 1213 in the base 1210, through side relief openings 1219 defined in the side of the cylindrical body 1215 of the base 1210, and through the circumferential gap 1209 into the surrounding atmosphere.

As the relief housing 1220 is moved away from the base 1210, as described above, the spring 1250 resists this movement and tends to pull the relief housing 1220 back toward the base 1210. The biasing force applied by the spring 1250 to the relief housing 1220 is a direct function of the distance in which the relief housing 1220 moves away from the base 1210. Thus, the magnitude of the biasing force applied by the spring 1250 is larger for larger relief gaps 1209 as compared to smaller relief gaps 1209. In at least one embodiment, this relationship is linearly proportional. That said, any suitable relationship between the lifted height of the relief housing 1220 and the biasing force tending to re-position the relief housing 1220 in its first, or vent, position can be used.

Notably, further to the above, the gasses flowing into the cavity 1213 defined in the base 1210 from the first tank 1120 will continue to flow into the cavity 1223 defined in relief housing 1220 and out the vent openings 1227 even though the relief gap 1209 between the relief housing 1220 and the seal 1230 is open. Thus, when the venting assembly 1200 is in its relief configuration, the vent openings 1227 and the side relief openings 1219 provide a dual exhaust for the gasses flowing into the venting assembly 1200. Moreover, further to the below, the gasses flowing through the side relief openings 1219 push upwardly on the skirt 1222 of the relief housing 1220 and, as a result, the lifting force pushing the relief housing 1220 upwardly when the venting assembly 1200 is in its relief configuration actually comprises a composite lifting force—a lifting force acting on the end wall 1226 and a lifting force acting on the skirt 1222. In various instances, this lifting force is sufficient to push the relief housing 1220 through its maximum stroke to its fully-open relief position, which is illustrated in FIGS. 6-8. In such a position, the side relief openings 1219 are wide open, or at least as exposed as they can be, and the venting assembly 1200 is providing its maximum relief. Once the inner tank 1120 has been sufficiently relieved, the lifting force being applied to the relief housing 1220 can be low enough to allow the spring 1250 to overcome the lifting force and pull the relief housing 1220 back into its first, or vent, position and close the relief gap 1209 between the relief housing 1220 and the seal 1230. In the event that the pressure in the inner tank 1120 increases once again, the relief housing 1220 will move back toward its second position and re-open the relief gap 1209 to provide relief venting through the side relief openings 1219.

As discussed above, the relief gap 1209 is created between the skirt 1222 of the relief housing 1220 and the seal 1230 when the relief housing 1220 is lifted away from the base 1210. Referring primarily to FIG. 8, the skirt 1222 comprises a flange extending angularly away from the cylindrical body 1221 of the relief housing 1220. The skirt 1222 extends downwardly toward the tank housing 1105 at a 30 degree angle measured from a plane extending orthogonally from the cylindrical body 1221. That said, the skirt 1222 can extend from the cylindrical body 1221 at any suitable angle. For instance, the skirt 1222 can extend downwardly at an angle between 25 degrees and 35 degrees as measured from the orthogonal plane, for example. Also, for instance, the skirt 1222 can extend downwardly at an angle between 15 degrees and 50 degrees as measured from the orthogonal plane, for example. The skirt 1222 has a first end attached to the cylindrical body 1221 and a distal, or free, end 1229b at the opposite end of the skirt 1222. The skirt 1222 has an inwardly-facing surface 1229a and an outwardly-facing surface 1229c. The thickness of the skirt 1222 between the inwardly-facing surface 1229a and the outwardly-facing surface 1229c is constant, or at least substantially constant, along the length of the skirt 1222. That said, other embodiments are envisioned in which the thickness of the skirt 1222 is not constant along the length thereof.

When the relief housing 1220 is in its first, or vent, position, further to the above, the inwardly-facing surface 1229a of the skirt 1222 is in contact with the seal 1230. When the relief housing 1220 is pushed away from the seal 1230 by the gasses flowing through the venting assembly 1200, as described above, the inwardly-facing surface 1229a of the skirt 1222 disengages from the seal 1230 to create the relief gap 1209. In such instances, as also described above, gasses flowing though the venting assembly 1200 can flow through the relief gap 1209 created between the inwardly-facing surface 1229a and the seal 1230. Moreover, the gasses flowing through the relief gap 1209 contact the inwardly-facing surface 1229a of the skirt 1222 and tend to push the relief housing 1220 away from the base 1210 and compress the spring 1250. The gasses then flow parallel to, or at least substantially parallel to, the inwardly-facing surface 1229a toward the distal end 1229b of the skirt 1222. After the gasses have flowed past the distal end 1229b, the gasses separate from the skirt 1222, and/or separate from the influence of the skirt 1222, and enter the atmosphere surrounding the fuel tank 1100. Notably, the distal end 1229b of the skirt 1222 has a laterally-facing flat surface extending between the inwardly-facing surface 1229a and the outwardly-facing surface 1229c. In this embodiment, the flat surface of the distal end 1229b extends orthogonally to a bottom surface, or plane, 1225 of the skirt 1222. Moreover, the flat surface of the distal end 1229b extends parallel to the translation of the relief housing 1220, for example. That said, the flat surface of the distal end 1229b can extend at any suitable angle relative to the bottom surface, or plane, 1225 of the skirt 1222.

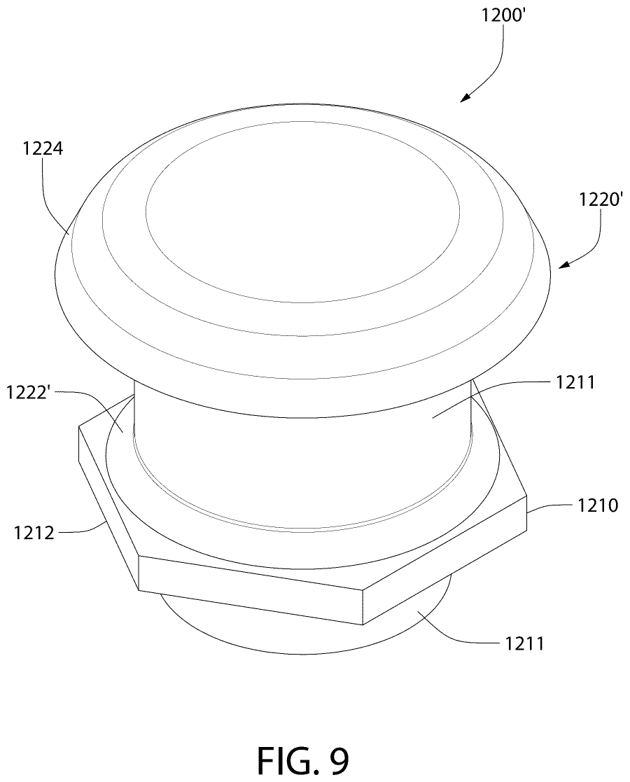

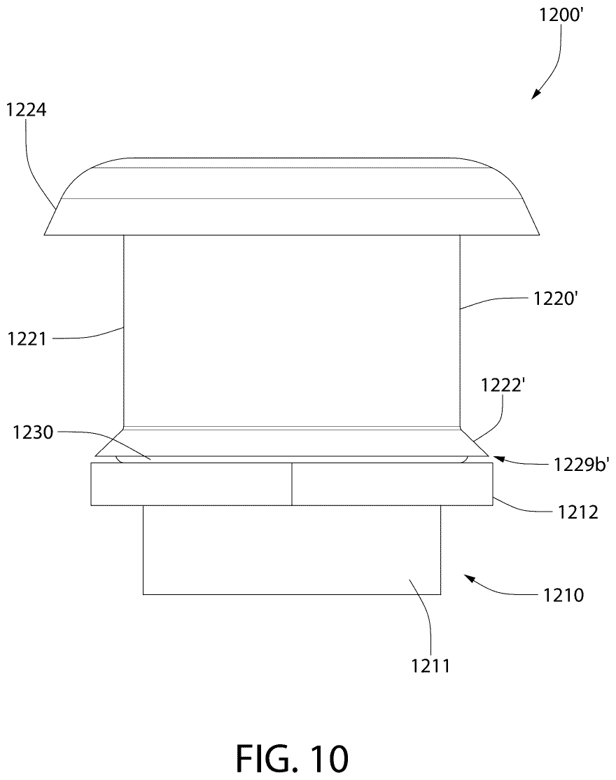

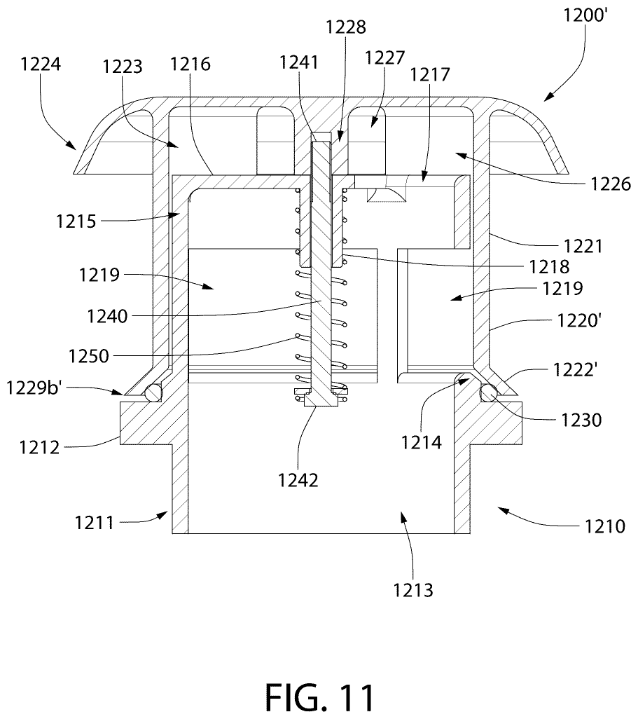

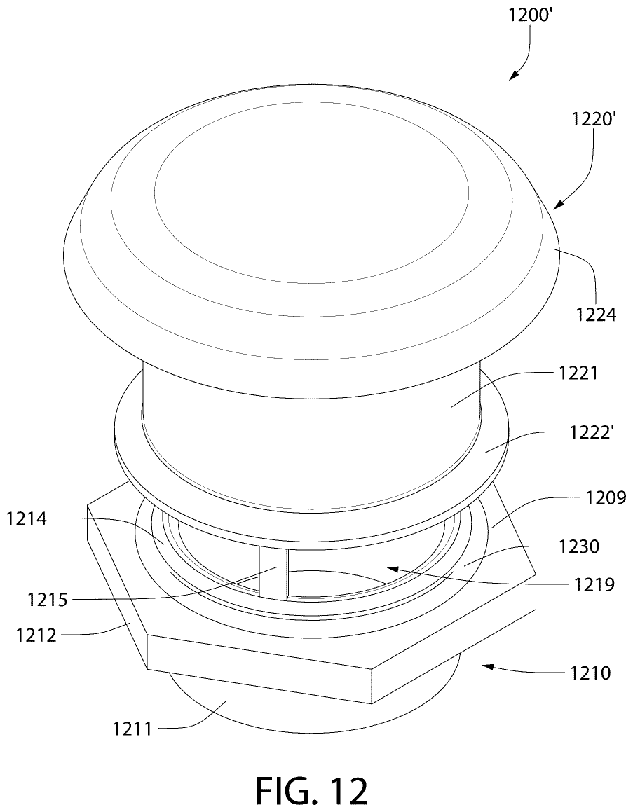

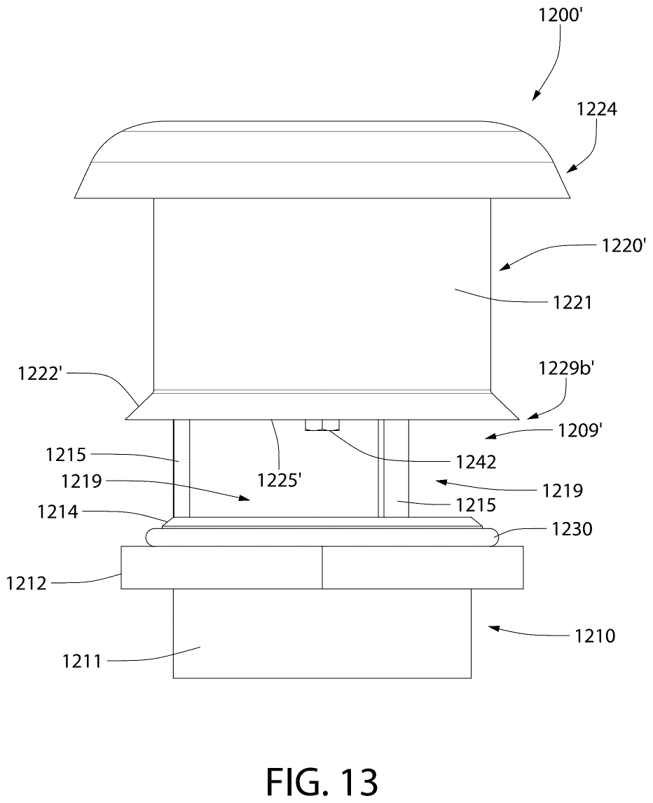

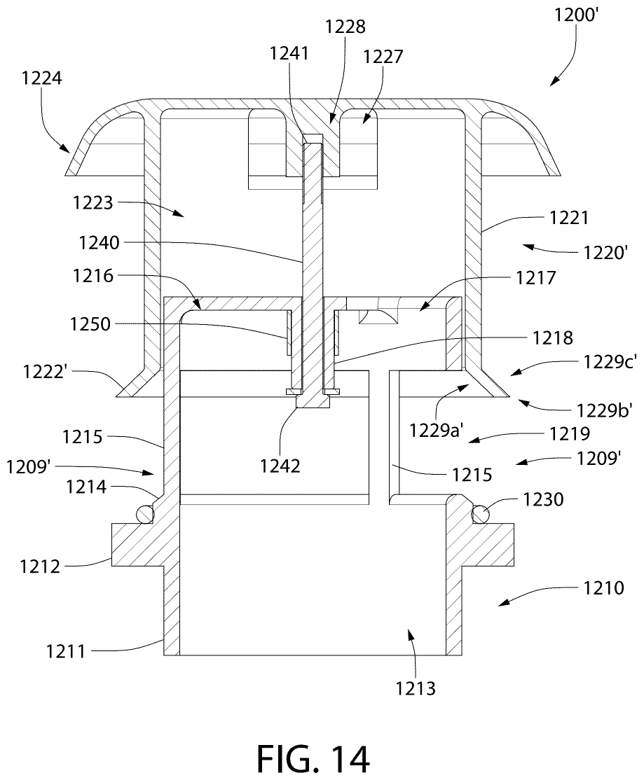

By way of comparison, further to the above, an alternative embodiment of the venting assembly 1200, i.e., venting assembly 1200′, is illustrated in FIGS. 9-14. Similar to the venting assembly 1200, the venting assembly 1200′ comprises a base 1210 and a relief housing 1220′ that is movable relative to the base 1210 between a first, or vent, position and a second, or relief, position to shift the venting assembly 1200′ between a vent configuration and a relief configuration, respectively. FIGS. 9-11 illustrate the venting assembly 1200′ in its vent configuration and FIGS. 12-14 illustrate the venting assembly 1200′ in its relief configuration. The venting assembly 1200′ is the same, or at least similar to, the venting assembly 1200 except for the relief housing 1220′. The relief housing 1220′ is the same, or at least similar to, the relief housing 1220 except that the relief housing 1220′ has a skirt 1222′ that has a different configuration than the skirt 1222. The skirt 1222′ has an inwardly facing surface 1229a′, an outwardly facing surface 1229c, and a first end attached to the cylindrical body 1221 of the relief housing 1220′. The skirt 1222′ also has a second end 1229b′ that comprises a downwardly-facing flat surface instead of the laterally-facing flat surface of the second end 1229b. As a result of this arrangement, absent other considerations, the inwardly-facing surface 1229a of the skirt 1222 has a larger surface area as compared to the inwardly-facing surface 1229a′ of the skirt 1222′ and, thus, the inwardly-facing surface 1229a of the skirt 1222 provides a larger surface against which the gasses flowing through the relief gap 1209 can push against. Such a larger surface area can provide a larger lifting force to the relief housing 1220 as compared to the relief housing 1220′, with all other considerations being equal. That said, not all embodiments and/or situations contemplated herein call for a larger lifting force and it is envisioned that the relief housing 1220′ may be preferable in some applications while the relief housing 1220 may be preferable in other applications.

As discussed herein, the venting assemblies 1200 and 1200′ comprise self-modulating, or self-regulating, venting systems. The venting assemblies 1220 and 1200′ automatically shift themselves between their vent configurations and their relief configurations in response to the pressure and flow rate of the gasses flowing there through. That said, embodiments are envisioned in which a venting assembly can be moved between its vent configuration and its relief configuration by at least one actuator. In at least one such embodiment, the venting assembly comprises a solenoid and/or a motor, for example, mechanically coupled to the relief housing which can drive the relief housing from its vent position to its relief position in response to an input from the controller of the tank assembly 1000, for instance. In various embodiments, the inner tank 1120 can comprise one or more pressure sensors in signal communication with the controller that can convey data to the controller regarding the pressure of the gasses in the inner tank 1120 such that the controller can evaluate the data from the pressure sensors to assess the pressure in the inner tank 1120, compare the assessed pressure in the inner tank 1120 to a predetermined threshold pressure, and open the venting assembly once the assessed pressure in the inner tank 1120 meets or exceeds the threshold pressure, for example. In various embodiments, the controller of the fuel tank assembly 1000 can be configured to drive the relief housing back into its vent position via the actuator when the pressure in the inner tank 1120 falls below the threshold pressure. In various instances, the controller can use two or more threshold pressures to control the state of the venting assembly. In at least one such instance, the controller can use a first threshold pressure for assessing whether to move the relief housing to its relief position and a second, or different, threshold pressure for assessing whether to move the relief housing back into its vent position. In at least one instance, the second threshold pressure is lower than the first threshold pressure. In such instances, chattering of the venting assembly between its vent configuration and its relief configuration can be avoided, or at least limited, when the gas pressure in the first tank 1120 fluctuates slightly above and below the first threshold pressure, for instance.

In various embodiments, any of the venting assemblies disclosed herein can comprise one or more pressure sensors. In at least one such embodiment, a pressure sensor is mounted to the base 1210 of a venting assembly 1200, for example, that is configured to sense the pressure of the gasses inside the venting assembly 1200. Similar to the above, such a pressure sensor can be in signal communication with the controller of the generator and/or the controller of the fuel tank assembly 1000. In various embodiments, an electrical wiring harness electrically connects the pressure sensor to the controller of the generator and/or the controller of the fuel tank assembly 1000. In at least one embodiment, the pressure sensor comprises a wireless signal transmitter configured to transmit data via one or more wireless signals which can be received by a wireless signal receiver of the controller of the generator and/or the controller of the fuel tank assembly.

In various embodiments, any of the venting assemblies disclosed herein can include at least one visual indicator configured to indicate whether the venting assembly is in its vent configuration or its relief configuration. In at least one embodiment, the base 1210 of the venting assembly 1200 has a first color and the relief housing 1220 has a second color that is different than the first color. When the relief housing 1220 moves into its second, or relief, position as described above, the first color of the base 1210, or at least a larger surface area of the base 1210, can be exposed which visibly indicates that the venting assembly 1200 is in its relief configuration. In at least one embodiment, the relief housing 1220 is comprised of a grey plastic, for example, and the base 1210 is also comprised of grey plastic except for the cylindrical body 1215 of the base 1210 which is comprised of a red plastic, for example. When the grey relief housing 1220 is in its first, or vent, position, in such embodiments, the red plastic of the cylindrical body 1215 is not visible, or at least not readily visible, from a position outside of the venting assembly 1200 and the entire venting assembly 1200 appears to be grey. When the relief housing 1220 moves into its second, or relief, position, the red cylindrical body 1215 is at least partially exposed which indicates that the venting assembly 1200 is in its relief configuration. When the relief housing 1220 returns, or resets, to its first, or vent, position, the red cylindrical body 1215 is no longer visible, or at least readily visible, to observer outside of the venting assembly 1200 which indicates that the venting assembly 1200 is in its vent configuration.

In various embodiments, any of the venting assemblies disclosed herein can comprise a visual indicator which is tripped when the venting assembly moves into its relief configuration. In at least one embodiment, the relief housing 1220 of the venting assembly 1200 toggles the visual indicator from a first visual state into a second visual state when the relief housing 12220 moves from its first, or vent, position into its second, or relief, position. In at least one embodiment, the visual indicator comprises a green display when the visual indicator is in its first visual state and a red visual display when the visual indicator is in its second visual state, for example. When the relief housing 1220 moves back into its first, or vent, position, however, the visual indicator remains in its second visual state. Such an arrangement allows an operator or a technician, for example, to understand that the venting assembly 1200 had previously entered its relief configuration even though the venting assembly 1200 may no longer be in its relief configuration. In various embodiments, the visual indicator comprises a mechanical dial, for example. In certain embodiments, the visual indicator comprises a digital display.

In various embodiments, further to the above, the visual indicator comprises a position sensor, such as a Hall Effect sensor, for example, mounted to the base 1210 and a detectable element, such as a magnet, for example, mounted to the relief housing 1220. When the relief housing 1220 is moved between its first, or vent, position, and its second, or relief, position as described above, the voltage output of the Hall Effect sensor changes owing to the movement of the detectable element mounted on the relief housing 1220 within a magnetic field created by the Hall Effect sensor. The venting assembly 1200 can comprise a control system including an electrical circuit and/or a processor in signal communication with the Hall Effect sensor that is configured to receive data from the Hall Effect sensor, process the data, assess the position of the relief housing 1220 based on the data, and operate the digital display according to the assessed position of the relief housing 1220. If the control system determines that the relief housing 1220 has not left its first, or vent, position, then the control system illuminates the digital display with a green color, for example. If the control system determines that the relief housing 1220 is in its second, or relief, position, or was previously in its second position, the control system illuminates the digital display with a red color, for example.

In various embodiments, further to the above, the visual indicator can comprise a reset feature which allows the visual indicator to be reset. In embodiments where the visual indicator comprises a mechanical dial, for instance, the venting assembly 1200 can comprise a reset button which, when depressed, manually resets the visual indicator. In embodiments where the visual indicator comprises a digital display, for instance, the venting assembly 1200 can comprise a reset button in signal communication with the control system of the venting assembly 1200 that, when depressed, creates a signal detectable by the control system to reset the digital display to its green color. As a result of the above, a technician or operator can address the reason that led to the venting assembly entering its relief configuration, and then reset the visual indicator once that reason has been addressed. If no reason can be found, the technician or operator can reset the visual indicator nonetheless.

In various embodiments, further to the above, the venting assembly, the controller of the fuel tank assembly, and/or the controller of the generator, for example, can be configured to emit a signal when the venting assembly is in its relief configuration. In at least one embodiment, the controller of the fuel tank assembly, for example, is in signal communication with a position sensor of the venting assembly, such as the Hall Effect sensor described above, and is configured to receive data from the position sensor. Similar to the above, the controller is configured to process the data and assess the position of the relief housing 1220 based on the data. In the event that the controller determines that the relief housing 1220 is in its second, or relief, position, the controller emits a signal via a wireless signal transmitter and/or a wired connection containing at least one datum that the venting assembly is in its relief configuration. A computer positioned remotely with respect to the fuel tank assembly can be configured to receive the signal, either wirelessly and/or through a wired connection, process the signal, and warn a technician or operator in proximity to the computer that the venting assembly is in its relief configuration. In various instances, the remote computer comprises a network, hub, and/or remote wireless device, such as a cell phone, for example.

As described above, the spring 1250 of the venting assembly 1200 comprises a linear spring, such as a metal coil spring, for example. In other embodiments, the spring 1250 comprises a non-linear spring. In various embodiments, the spring 1250 comprises a rubber element.

Moreover, as also described above, the spring 1250 permits the vent housing 1220 to move incrementally in response to the pressure and/or flow rate of the gasses flowing through the venting assembly 1200. In various other embodiments, the venting assembly 1200 comprises a detent, or a series of detents, that are configured to releasably hold the vent housing 1200 in a series of positions. For instance, the base 1210 can comprise a first detent that releasably holds the vent housing in its first position when the pressure and/or flow rate of the gasses flowing through the venting assembly 1200 is below a first threshold, a second detent that releasably holds the vent housing 1200 in a first relief position when the pressure and/or flow of the gasses flowing through the venting assembly 1200 is above the first threshold but below a second threshold, and a third detent that releasably holds the vent housing 1200 in a second relief position when the pressure and/or flow of the gasses flowing through the venting assembly 1200 is above the second threshold. In this example, the relief gap 1209 of the venting assembly 1200 is larger when the vent housing 1220 is in its second relief position as compared to its first relief position. In at least one such embodiment, the first detent, the second detent, and the third detent are positioned and arranged in a linear array and the movement of the relief housing 1220 past a detent creates a snap-action that allows the relief housing 1220 to jump from its first position to its first relief position and from its first relief position to its second relief position, for example. Regardless of the position and arrangement of the detents, the spring 1250 is configured to pull the relief housing 1220 past the detents to return the vent housing 1220 to its first, or vent, position when the pressure and/or flow rate of the gasses flowing through the venting assembly 1200 falls below a threshold, as described above.

As described above, the relief housing 1220 of the venting assembly 1200 is configured to translate relative to the base 1210. In other embodiments, a venting assembly comprises a base and a relief housing that rotates relative to the base in order to open side relief openings, such as side relief openings 1219, for example, in response to the pressure and/or flow rate of the gasses flowing through the venting assembly. In such embodiments, the relief housing rotates between a first, or vent, position in which gas can flow through vent openings, such as vent openings 1227, for example, at the top of the relief housing and a second, or relief, position in which the side relief openings 1219 can provide additional relief to the pressure and/or flow rate of the gasses flowing through the venting assembly. In at least one such embodiment, the venting assembly comprises a torsional spring, for example, that resists the rotation of the vent housing from its first position to its second position and also biases the relief housing back into its first position.

As described herein, the venting assemblies 1200 and 1200′, for example, are responsive to the pressure and/or flow rates of the gasses flowing therethrough. In various embodiments, a venting assembly is responsive to the temperature of the gasses flowing therethrough. In at least one such embodiment, the venting assembly can comprise a base 1210, a relief housing 1220, and a bimetallic strip that connects the base 1210 and the relief housing 1220 which is configured to control the position of the relief housing 1220 relative to the base 1210 in response to the temperature of the gasses flowing through the venting assembly.

As described above, the fuel tank 1100 comprises two venting assemblies 1200 - one venting assembly 1200 that vents the inner tank 1120 and one venting assembly 1200 that vents the outer tank 1130. To the extent that a venting assembly 1200 is described herein in connection with the inner tank 1120, for example, such description also applies to the venting assembly 1200 in connection with the outer tank 1130, and vice versa.

Further to the above, a controller of the generator and/or a controller of a fuel tank assembly can be configured to implement any of the methods, steps, functions, and/or actions disclosed herein. In various embodiments, all of the methods, steps, functions, and/or actions disclosed herein are implemented by the controller of the generator. In other embodiments, all of the methods, steps, functions, and/or actions disclosed herein are implemented by the controller of the fuel tank assembly. In yet other embodiments, some of the methods, steps, functions, and/or actions disclosed herein are performed by the controller of the generator while other methods, steps, functions, and/or actions disclosed herein are performed by the controller of the fuel tank assembly. In various embodiments, all or some of the methods, steps, functions, and/or actions disclosed herein are implemented by a controller of the venting assembly.

In various embodiments, a controller described herein can comprise any suitable computer, processor, computer-readable medium, and/or circuit.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Accordingly, the disclosure is considered to include any one or more of a computer-readable medium or a distribution medium and other equivalents and successor media, in which data or instructions may be stored. The computer-readable medium may be non-transitory, which includes all tangible computer-readable media.

Dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Processors suitable for the execution of a computer program include, by way of example, both general and special purpose microprocessors, and anyone or more processors of any kind of digital computer. Generally, a processor may receive instructions and data from a read only memory or a random access memory or both.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

1. A fuel tank, comprising:
a tank, comprising:
a tank housing defining a tank cavity configured to store a fuel therein; and
a port defined in the tank housing in communication with the tank cavity; and
a venting system, comprising:
a base attached to the tank housing, wherein the base defines a base cavity in fluid communication with the tank cavity through the port; and
a relief housing movably connected to the base, wherein the relief housing is movable between a first position and a second position, wherein a sealed interface is defined between the base and the relief housing when the relief housing is in its first position, wherein the relief housing comprises an open vent aperture in fluid communication with the base cavity, wherein gas may vent from the tank through the open vent aperture when the relief housing is in its first position, and wherein the sealed interface is unsealed when the relief housing is in its second position to expose a relief vent aperture in the base.

2. The fuel tank of claim 1, wherein the sealed interface comprises a seal extending around the base.

3. The fuel tank of claim 2, wherein the relief housing comprises a cylindrical body and a skirt extending from the cylindrical body, wherein the base is at least partially positioned in the cylindrical body, and wherein the seal is positioned intermediate the base and the skirt when the relief housing is in its first position.

4. The fuel tank of claim 3, further comprising a spring configured to bias the relief housing into its first position, wherein the spring biases the skirt into compression against the seal when the relief housing is in its first position.

5. The fuel tank of claim 3, wherein a relief gap is defined between the skirt and the seal when the relief housing is in its second position.

6. The fuel tank of claim 3, wherein the skirt comprises:
an inwardly-facing surface facing toward the seal;
an outwardly-facing surface positioned opposite the inwardly-facing surface;
a proximal end connected to the cylindrical body; and
a distal end including a flat surface.

7. The fuel tank of claim 6, wherein the base defines a longitudinal axis, wherein the base is configured to constrain the movement of the relief housing relative to the base along the longitudinal axis, and wherein the flat surface extends parallel to the longitudinal axis.

8. The fuel tank of claim 7, wherein the relief vent aperture is positioned intermediate the longitudinal axis and the skirt.

9. The fuel tank of claim 1, wherein the base comprises a connector and a chamber wall, wherein the connector connects the base to the tank housing, wherein the chamber wall extends from the connector into the relief housing, and wherein the relief vent aperture is defined in the chamber wall.

10. The fuel tank of claim 9, wherein the relief vent aperture is intermediate the connector and the open vent aperture.

11. The fuel tank of claim 9, wherein the chamber wall is entirely surrounded by the relief housing when the relief housing is in its first position, and wherein at least a portion of the chamber wall is not surrounded by the relief housing when the relief housing is in its second position.

12. The fuel tank of claim 9, wherein the chamber wall of the base has a first color and the relief housing has a second color that is different than the first color.

13. The fuel tank of claim 12, wherein the first color is not observable from outside of the venting system when the relief housing is in its first position, and wherein the first color is observable from outside of the venting system when the relief housing is in its second position.

14. (canceled)

15. (canceled)

16. The fuel tank of claim 1, wherein the open vent aperture moves relative to the relief vent aperture when the relief housing moves between its first position and its second position.

17. The fuel tank of claim 1, wherein the base comprises a first detent configured to releasably hold the relief housing in its first position and a second detent configured to releasably hold the relief housing in its second position.

18-20. (canceled)

21. The fuel tank of claim 1, wherein the venting system further comprises a position sensor configured to sense the position of the relief housing relative to the base.

22-28. (canceled)

29. The fuel tank of claim 1, further comprising a visual indicator that indicates the current position of the relief housing relative to the base.

30-37. (canceled)

38. The fuel tank of claim 1, wherein the venting system further comprises a pressure sensor configured to measure the gas pressure in the venting system.

39. (canceled)

40. (canceled)

41. The fuel tank of any one of claim 1, further comprising an actuator configured to move the relief housing from its first position to its second position.

42. A fluid tank, comprising:
a tank, comprising:
a tank housing defining a tank cavity configured to store a liquid therein; and
a port defined in the tank housing in communication with the tank cavity; and
a venting system, comprising:
a base attached to the tank housing, wherein the base defines a base cavity in fluid communication with the tank cavity through the port; and
a relief housing movably connected to the base, wherein the relief housing is movable between a first position and a second position, wherein a sealed interface is defined between the base and the relief housing when the relief housing is in its first position, wherein the relief housing comprises an open vent aperture in fluid communication with the base cavity, wherein gas may vent from the tank through the open vent aperture when the relief housing is in its first position, and wherein the sealed interface is unsealed when the relief housing is in its second position to expose a relief vent aperture.
